(19) United States
(12) Patent Application Publication
(10) Pub. No.: US 2005/0230300 A1
(43) Pub. Date: Oct. 20, 2005

(54) Oil filter apparatus

(75) Inventor: Yuji Kato, Kanagawa (JP)

Correspondence Address: FOLEY AND LARDNER;SUITE 500, 3000 K STREET NW, WASHINGTON, DC, 20007, US

(73) Assignee: HITACHI, LTD.

(21) Appl. No.: 11/104,495

(22) Filed: Apr. 13, 2005

(30) Foreign Application Priority Data
Apr. 14, 2004 (JP) 2004-118811

(51) Int. Cl. B01D 35/14

(52) U.S. Cl. 210/234; 210/235

(57) ABSTRACT

An oil filter apparatus includes a filter element, a housing having a housing body and a cap to accommodate therein the filter element, an oil drain passage defined by the housing, and a drain valve unit mounted to the drain passage. The drain valve unit includes a protrusion arranged movably in an opening of the drain passage and having an end in contact with the filter element, a biasing mechanism that biases the protrusion toward the filter element, stoppers formed around and integral with the protrusion to prevent the protrusion from protruding excessively through the passage opening upon contact of the stoppers with a portion of the drain passage adjacent to the passage opening, an opening/closing mechanism that opens and closes the drain passage in response to a movement of the protrusion, and a rib formed integral with the protrusion to extend between the stoppers toward the protrusion end.

### BACKGROUND OF THE INVENTION

The present invention relates to an oil filter apparatus for filtering out a foreign substance from oil, particularly of the type having a drain valve unit that drains the oil to prevent an oil overflow at the time when the oil filter apparatus becomes disassembled for filter replacement.

Conventionally, an oil filter apparatus includes a housing having a housing body and a cap attached to the housing body and a filter element disposed in the housing such that the filter element can be replaced with a new one upon detachment of the cap from the housing body. Since the filter apparatus receives a pressurized oil supply from an oil pump, there is a possibility of the oil overflowing from the housing at the time when the cap becomes detached from the housing body. In order to avoid such oil overflow, Japanese Laid-Open Patent Publication No. 2003-232208 proposes the installation of a drain valve unit in the filter apparatus to drain the oil out of the housing upon detachment of the cap from the housing body.

### SUMMARY OF THE INVENTION

The drain valve unit generally includes a ball-shaped valve element and a retainer held under a tension by a spring toward the filter element in such a manner as to seat the valve element on the valve seat. The retainer has a protrusion held in contact with the filter element and a stopper mechanism arranged around the protrusion to limit an excessive movement of the protrusion and thereby prevent the protrusion from falling off. When the retainer moves against the spring tension with the protrusion held in contact with the filter element, the protrusion sustains a reaction force from the spring. It is conceivable that the protrusion may be made with a larger diameter so as to attain strength against the reaction force from the spring. In such a case, however, not only the protrusion but also the stopper mechanism increase in diameter. This results in an increased size of the drain valve unit, thereby decreasing the installability (mountability) of the valve unit into the filter apparatus.

It is therefore an object of the present invention to provide an oil filter apparatus that includes a drain valve unit having a valve protrusion strengthened without an increase in size for miniaturization and simplification of the oil filter apparatus.

According to a first aspect of the invention, there is provided an oil filter apparatus, comprising: a filter element; a housing accommodating therein the filter element and having a housing body and a cap attached to the housing body; an oil drain passage defined by the housing; and a drain valve unit mounted to the oil drain passage, the drain valve unit comprising: a protrusion arranged movably in an opening of the oil drain passage and having an end in contact with the filter element; a biasing mechanism that biases the protrusion toward the filter element; a plurality of stoppers formed around and being integral with the protrusion so as to prevent the protrusion from protruding excessively through the passage opening upon contact of the stoppers with a portion of the oil drain passage adjacent to the passage opening; an opening/closing mechanism that opens and closes the oil drain passage in response to a movement of the protrusion; and a rib formed integral with the protrusion so as to extend between the stoppers toward the protrusion end.

According to a second aspect of the invention, there is provided an oil filter apparatus, comprising: a filter element; a housing accommodating therein the filter element and having a housing body and a cap attached to the housing body, the housing body defining therein an oil drain passage; a protrusion movably arranged in an opening of the oil drain passage and having a spherical end in contact with the filter element; a biasing mechanism that biases the protrusion toward the filter element; a stopper formed integrally with the protrusion so as to prevent the protrusion from protruding excessively through the passage opening upon contact of the stopper with a portion of the oil drain passage adjacent to the passage opening; an opening/closing mechanism that opens and closes the oil drain passage in response to a movement of the protrusion; and a triangular rib formed integrally with the protrusion so as to extend toward the protrusion end.

According to a third aspect of the invention, there is provided an oil filter apparatus, comprising: a filter element; a housing accommodating therein the filter element and having a housing body and a cap attached to the housing body, the housing body defining therein an oil drain passage; a protrusion movably arranged in an opening of the oil drain passage and having an end in contact with the filter element; a biasing mechanism that biases the protrusion toward the filter element; an opening/closing mechanism that opens and closes the oil drain passage in response to a movement of the protrusion; a rib formed integrally with the protrusion so as to extend toward the protrusion end; and a retaining mechanism arranged adjacent to the oil drain passage opening, the retaining mechanism being released from the rib at the time of placing the filter element in position upon attachment of the cap to the housing body and then being engaged with the rib so as to prevent an axial movement of the protrusion at the time of dismounting the filter element upon detachment of the cap from the housing body.

The other objects and features of the invention will also become understood from the following description.

### BRIEF DESCRIPTION OF THE DRAWINGS

FIG. 1 is a section view of an oil filter apparatus according to a first embodiment of the invention.

FIG. 2 is a perspective view of a drain valve unit of the oil filter apparatus according to the first embodiment of the invention.

FIG. 3 is a magnified section view of part of the oil filter apparatus, when cut across a stopper mechanism of the drain valve unit, according to the first embodiment of the invention.

FIG. 4 is a magnified section view of part of the oil filter apparatus, when cut across reinforcing ribs of the drain valve unit, according to the first embodiment of the invention.

FIG. 5 is a section view of the oil filter apparatus in a condition where the filter and the drain valve unit are placed in the filter housing before the cap becomes screwed into the housing body according to the first embodiment of the invention.

FIG. 6 is a section view of a drain valve unit according to a second embodiment of the invention.

FIG. 7A is a section view of a drain valve unit according to a third embodiment of the invention.

FIG. 7B is a magnified section view of part of an oil filter apparatus according to the third embodiment of the invention.

### DESCRIPTION OF THE EMBODIMENTS

The present invention will be described below by way of the following first to third exemplary embodiment, in which like parts and portions are designated by like reference numerals to avoid repeated explanations thereof.

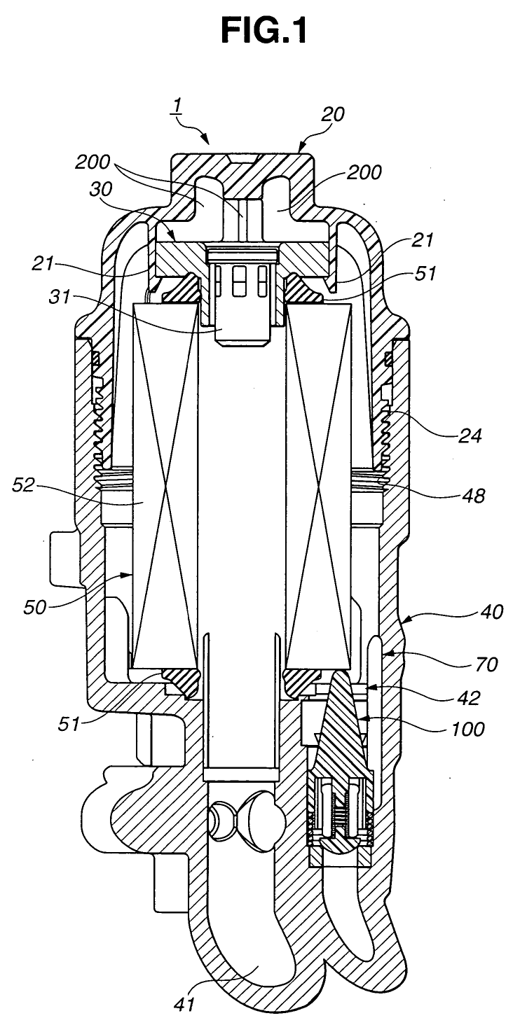

Referring to FIG. 1, an oil filter apparatus 1 of the first embodiment includes an oil filter 50, a filter housing accommodating therein the filter 50 and having a housing body 40 and a cap (or lid) 20 detachably fixed to the housing body 40, a relief valve unit 30 arranged between the filter 50 and the cap 20 and a drain valve unit 100 mounted to the housing.

The filter 50 has a cylindrical hollow filter element 52 for filtering out a foreign substance (such as dust) from oil. There is some space left between the filter element 52 and the housing body 40 and between the filter element 52 and the cap 20 to define an oil inlet passage into which the oil is fed from an oil pump when the filter 50 is installed in the housing. There is further defined through the filter element 52 an oil outlet passage in which the filtered oil flows. The filter 50 also has elastic members 51 arranged at axially opposite ends of the filter element 52. The elastic members 51 contact the relief valve unit 30 and the housing body 40, respectively, thereby functioning as a sealing and shock-absorbing material, when the filter 50 is placed in position within the filter apparatus 1. The elastic members 51 are made of rubber in the first embodiment.

The housing body 40 is substantially bottomed cylindrical in shape, and has a gallery hole 41 and a drain valve hole 42 formed in a bottom end thereof. The gallery hole 41 is located in a center portion of the bottom end of the housing body 40 so as to introduce therethrough the filtered oil from the oil outlet passage into a main oil gallery. The drain valve hole 42 is opened at a peripheral portion of the bottom end of the housing body 40 so as to accommodate therein the drain valve unit 100. The housing body 40 also has a communication hole 70 formed in a side wall thereof to provide a communication between the housing body 40 and the drain valve hole 42 and thereby return the oil from the housing body 40 to the oil pump via the communication hole 70 and the drain valve hole 42 at the time of replacement of the filter 50 (as will be explained below in detail). Namely, the drain valve hole 42 and the communication hole 70 constitute part of an oil drain passage in the first embodiment. A thread 48 is cut in an inner circumferential surface of the housing body 40 for engagement with the cap 20.

The cap 20 is substantially cylindrical in shape and made of a resin. Further, the cap 20 has a closed cap end and a plurality of reinforcing ribs 200 and retaining pawls 21 formed on an inner surface of the cap end. The ribs 200 protrude toward the inside of the cap 20 in a radial arrangement with respect to the cap end center so as to axially retain the relief valve unit 30. The pawls 21 have hook ends so as to retain thereon the relief valve unit 30 and prevent the relief valve unit 30 from falling off into the housing body 40. Both of the ribs 200 and the pawls 21 are integrally formed with the cap 20 in the first embodiment. A thread 24 is cut in an outer circumferential surface of the cap 20 so that the cap 20 is screwed into the housing body 40 by engagement of the threads 24 and 48.

The relief valve unit 30 includes a hollow valve structure and a relief valve 31 fitted in an axial hollow portion of the valve structure. The relief valve 31 has a valve hole and a valve element. The relief valve element is held under a tension by a coil spring so as to close the valve hole under normal conditions, and then, is moved against the spring tension so as to open the valve hole, when there arises a pressure difference between upstream and downstream sides of the filter element 52 (i.e. between the oil inlet and outlet passages) exceeding a predetermined level, and thereby allow the oil to flow from the oil inlet passage into the oil outlet passage directly through the relief valve hole while bypassing the filter element 52.

The drain valve unit 100 comes into a valve open state when the cap 20 becomes unscrewed from the housing body 40 for replacement of the filter 50, in order to drain the oil out of the housing body 40 through the holes 42 and 70 and return the oil into the oil pump without the oil overflowing from the housing.

The structure of the drain valve unit 100 will be now explained below in detail.

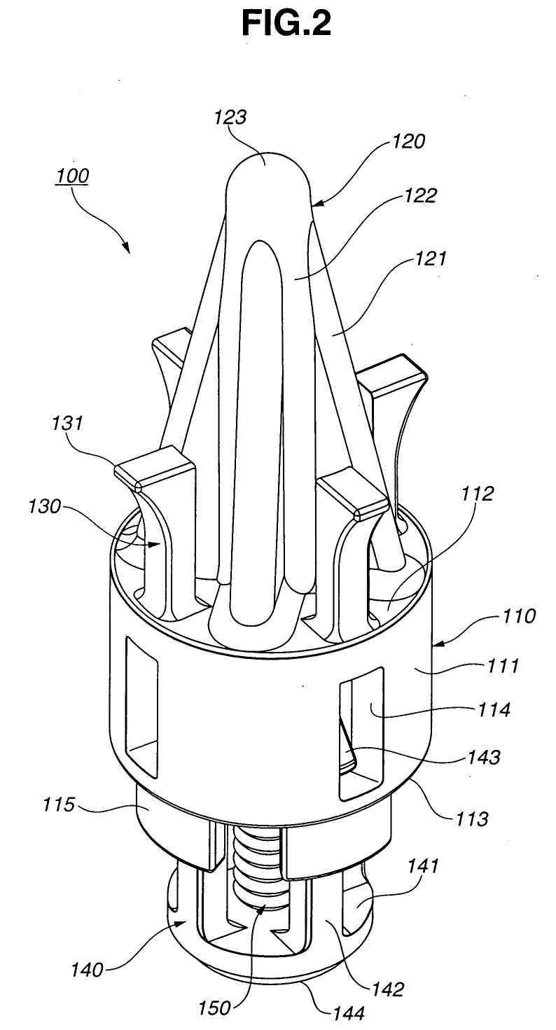

As shown in FIG. 2, the drain valve unit 100 is generally made of a synthetic resin having elasticity, and includes a retainer 110, a protrusion 120, stoppers 130 (as a stopper mechanism), a drain valve 140 (as a valve element) and inner and outer springs 150 and 47 (as a biasing mechanism or elements).

The retainer 110 is formed into a substantially cylindrical shape with a circumferential surface 111 and two opposite ends 112 and 113, and is arranged axially movably in the drain valve hole 42 with the circumferential surface 111 held in sliding contact with a wall surface of the drain valve hole 42.

Both of the protrusion 120 and the stoppers 130 are formed integrally with the upper end 112 of the retainer 110 in such a manner as to protrude from the retainer end 112.

The protrusion 120 is substantially cylindrical in shape and located at the center of the retainer end 112. In the first embodiment, the protrusion 120 is made smaller in diameter than the retainer 110. Further, the protrusion 120 has a spherical end 123 and four ribs 121 extending integrally toward the protrusion end 123. The spherical protrusion end 123 makes point contact with a bottom end face potion 53 of the filter element 52 when the drain valve unit 100 is placed in position within the filter apparatus 1. The ribs 121 are circumferentially evenly spaced around the protrusion 120 and substantially right-triangular in shape so that each of the ribs 121 is integral at a radial side thereof with the end 112 of the retainer 110 and integral at an axial side thereof with the circumferential surface 122 of the protrusion 120.

The stoppers 130 are circumferentially evenly spaced around and located radially outwardly of the protrusion 120. Each of the stoppers 130 has a retaining pawl 131 of circumferential width at an axial end thereof. The pawls 131 extend radially outwardly such that the drain valve unit 100 becomes largest in diameter when taken along the pawls 131.

Herein, four ribs 121 and four stoppers 130 are alternatingly aligned in such a manner that each stopper 130 extends between any adjacent two ribs 120 in the first embodiment. With such an alignment, the ribs 121 and the stoppers 130 do not interfere with each other.

The retainer 110 also has a cylindrical hollow retainer seat 115 formed integral with and smaller in diameter than the retainer end 113, and some circumferential portions of the retainer seat 115 are cut away. Besides, rectangular holes 114 are made through the circumferential surface 111 of the retainer 110.

The drain valve 140 is mounted on the other end 113 of the retainer 110, and includes a disc-shaped valve seat portion 141 and four valve holding portions 142 integral with the valve seat portion 141. The valve seat portion 141 has a semispherical valve stopper 144 formed at an axial end thereof opposite to the retainer 110. The valve holding portions 142 are circumferentially evenly spaced and have pawls 143 at axial ends thereof engaged into the retainer holes 114 in such a manner as to allow a relative axial sliding movement between the retainer 110 and the drain valve 140 within the retainer seat 115 but prevent a relative radial displacement between the retainer 110 and the drain valve 140. Namely, the retainer seat 115 allows positioning of the drain valve 140

The inner spring 150 is arranged between the retainer 110 and the drain valve 140 and has two opposite spring ends held in contact with the cylindrical end face of the retainer 110 and the cylindrical end face of the valve seat portion 141, respectively, so as to axially bias the retainer 110 and the drain valve 140 away from each other. The retainer 110 and the drain valve 140 are displaced from each other under a tension of the inner spring 150, but are prevented from excessive relative displacement by engagement of the valve pawls 143 and the retainer holes 114. The outer spring 47 is arranged around the retainer seat 115 so as to bias the retainer 110 toward an opening of the drain valve hole 42.

The positioning and operations of the drain valve unit 100 in the oil filter apparatus 1 will be explained in more detail below.

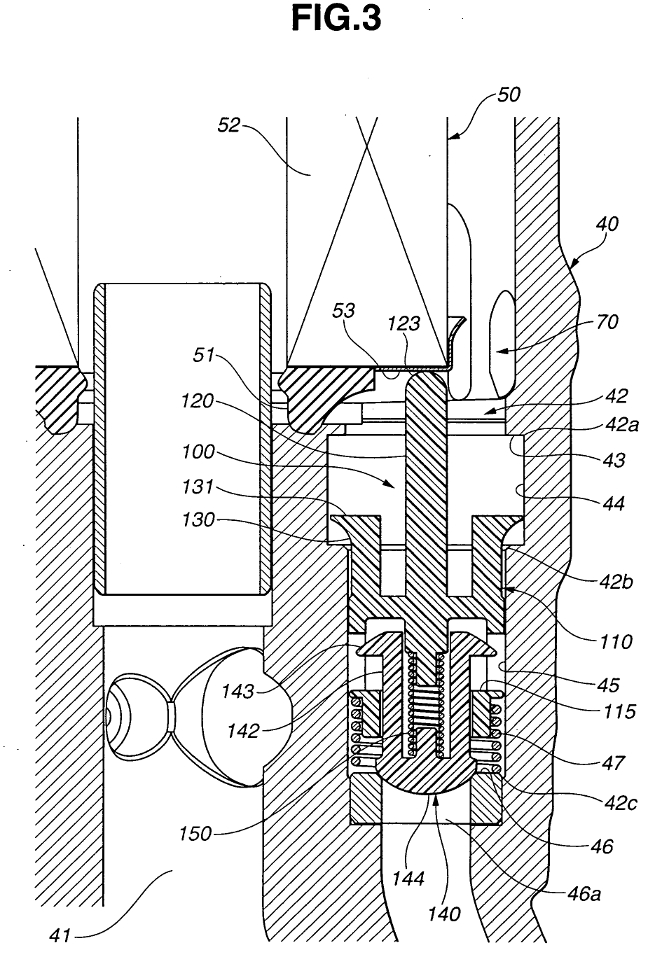

In the first embodiment, the drain valve hole 42 has three steps: first, second and third steps 42a, 42b and 42c formed therein (in the order from the side of the opening of the drain valve hole 42), as shown in FIG. 3, to define a stopper retaining portion 43, a stopper sliding portion 44, a retainer sliding portion 45 and a valve seat portion 46. More specifically, the stopper retaining portion 43 is defined as a radially-extending surface portion of the step 42a adjacent to the opening of the drain valve hole 42, and the stopper sliding portion 44 is defined as an axially-extending portion of the inner wall surface of the drain valve hole 42 between the steps 42a and 42b. When the drain valve unit 100 slides up toward the filter element 52, the stopper retaining portion 43 contacts and retains thereon the pawls 131 of the stoppers 130, thereby preventing the stoppers 130 from moving excessively upward through the opening of the drain valve hole 42. The stopper sliding portion 44 has such a diameter as to allow the stopper pawls 131 to slide axially in the stopper sliding portion 44. The retainer sliding portion 45 is defined as a portion of the inner wall surface of the drain valve hole 42 between the steps 42b and 42c, and has such a diameter as to allow the retainer 110 to slide axially, with the retainer circumferential surface 111 held in sliding contact with the retainer sliding portion 45, but lock the retainer 100 radially. The valve seat portion 46 is defined by the step 42c and formed with a bore 46a. When the drain valve unit 100 is placed in position, the valve stopper 144 and the valve seat portion 46 contacts each other to prevent the drain valve unit 100 from moving excessively downward. Herein, the retainer sliding portion 45 is made smaller in diameter than the stopper retaining portion 44, and the valve seat portion 46 is made smaller in diameter than the retainer sliding portion 45.

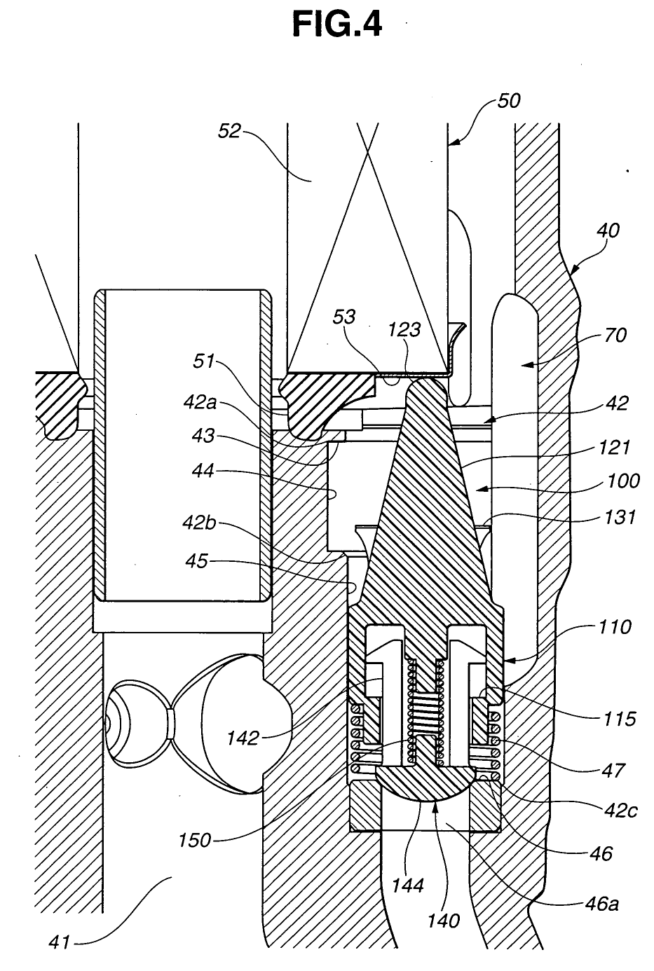

As shown in FIG. 4, the communication hole 70 is cut in the inner side wall of the housing body 40 so as to extend from the interior of the housing body 40 to the interior of the valve drain hole 42 (specifically, the retainer sliding portion 45) through the steps 42a and 42b in the first embodiment.

When the cap 20 is attached to the housing body 40 such that the filter 50 is seated on the bottom end of the housing body 40, the filter element 52 pushes the protrusion 120 downward. In response to such an input from the cap 20, the valve retainer 110 moves against the tension of the springs 47 and 150 to seat the drain valve 140 on the valve seat 46 and close the valve seat bore 46a with the valve stopper 40. In this state, the communication hole 70 is closed with the valve retainer 110. The communication between the filter housing and the oil drain passage is thus interrupted, whereby the oil cannot flow into the oil pump. When the cap 20 is detached from the housing body 40, the valve retainer 110 moves under the tension of the springs 47 and 150 toward the opening of the drain valve hole 42 to release the drain valve 140 from the valve seat 46 and open the communication hole 70. The communication between the filter housing and the oil drain passage is then allowed to let the oil into the oil pump.

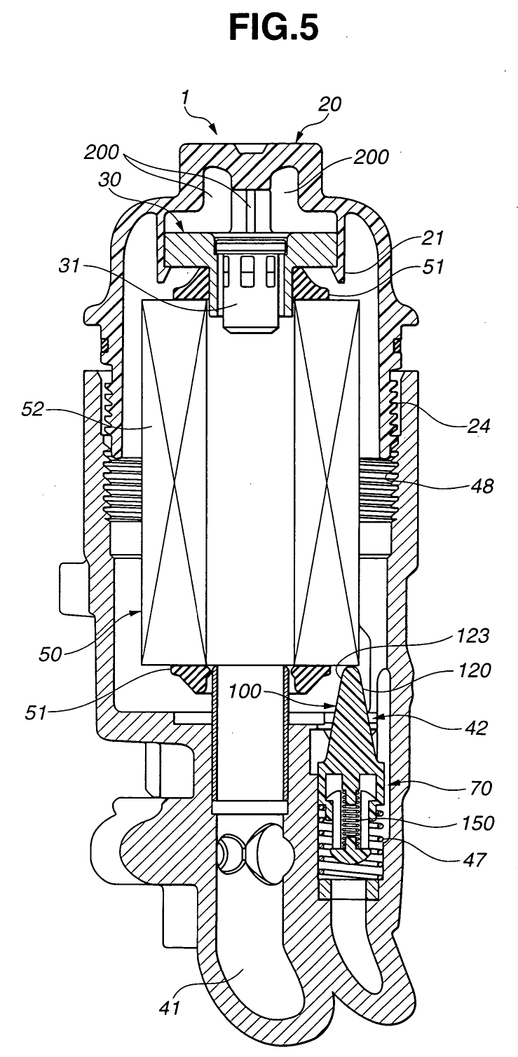

The above-structured oil filter apparatus 1 can be manufactured by the following procedure as shown in FIG. 5.

The outer spring 47 is first inserted into the valve drain hole 72 and retained axially on the valve seat 46 in such a manner as to extend and contract axially along the retainer sliding portion 45.

Next, the subassembly of the valve retainer 110, the protrusion 120, the stoppers 130, the drain valve 140 and the inner spring 150 is inserted into the valve drain hole 72. The opening of the valve drain hole 72 and the valve retainer 100 of the drain valve unit 100 have substantially the same diameter. By contrast, the pawls 131 are located most radially outwardly in the drain valve unit 100 and made larger in diameter than the opening of the valve drain hole 72. When the drain valve unit 100 is inserted into the drain valve hole 42 through its opening, the elastic resinous pawls 131 become deformed radially inwardly. The pawls 131 recover their original shape and come into contact with the stopper sliding portion 44 (or the stopper retaining portion 43) after the insertion of the drain valve 100 into the drain valve hole 42. Upon placement of the drain valve unit 100 in the drain valve hole 42, the outer spring 47 becomes retained between the retainer seat 115 and the retainer sliding portion 45 with its two axially opposite ends contacting the retainer end 113 and the valve seat potion 146, respectively, so as to biases the valve retainer 110 axially toward the opening of the valve drain hole 42. As the valve retainer 110 and the protrusion 120 are integral with the each other, the protrusion 120 also becomes biased under the tension of the inner and outer springs 150 and 47 at this time in such a manner that the protrusion end 123 always protrudes through the opening of the valve drain hole 42.

The filter 50 is then placed in the housing body 40. As the protrusion end 123 is protruding from the opening of the valve drain hole 42 as mentioned above, the protrusion end 123 contacts the bottom end face portion 53 of the filter element 52 before the filter 50 is seated on the bottom of the housing body 40. The protrusion 120 becomes depressed under the weight of the filter 50 upon contact of the protrusion end 123 with the filter element 52. However, the tension of the inner and outer springs 150 and 47 is herein set higher than the gravitational weight force of the filter 50 such that the filter 50 is biased by the protrusion end 123 toward the opening of the housing body 40. Thus, the filter 50 cannot be seated on the bottom of the housing body 40 just by placing the filter 50 in the housing body 40.

After the installation of the relief valve 30, the cap 20 is screwed in the housing body 40 by engagement of the threads 24 and 48. Then, the filter 50 becomes axially depressed and seated on the bottom of the housing body 40 against the tension from the protrusion end 123 such that the filter element 52 is held between the relief valve unit 30 and the housing body 40 via the elastic members 51.

As described above, the drain valve unit 100 is installed in the oil filter apparatus 1 in order to return the oil from the filter housing into the oil pump and prevent the oil overflow from the filter housing upon detachment of the cap 20 from the housing body 40. The protrusion 120 of the drain valve unit 100 is moved against the tension of the inner and outer valve springs 150 and 47 while being held in contact with the filter element 52. The valve protrusion 120 thus receives a large reaction force from the springs 150 and 47. For this reason, it is desired that the valve protrusion 120 require high strength.

In a conventional drain valve unit, a valve protrusion is made with a larger diameter to secure sufficient strength. Although a stopper mechanism is provided around the valve protrusion in the drain valve unit to limit an excessive protruding movement of the protrusion, not only the valve protrusion but also the stopper mechanism become large in diameter. This results in an increase in valve size, whereby the conventional drain valve deteriorates in its installability (mountability) into an oil filter apparatus.

In the first embodiment, on the other hand, the triangular reinforcing ribs 121 are formed integrally at their radial sides with the end 112 of the retainer 112 and at their axial sides with the circumferential surface 122 of the protrusion 120 and circumferentially equally spaced around the protrusion 120. The protrusion 120 is thus able to secure sufficient strength without an increase in diameter. In addition, four alternating stoppers 130 and four ribs 121 are aligned radially so as not to interfere with each other so that the stoppers 130 can be thus prevented from being located at radially outward positions (i.e. the stopper mechanism does not become increased in diameter). It is therefore possible in the first embodiment to secure high strength of the protrusion 120 while allowing size reduction of the drain valve unit 100.

Further, the retainer 110, the protrusion 120, the stoppers 130 and the pawls 131 are formed integrally of elastic resinous material in the first embodiment. The protrusion 120 and the pawls 131 can be formed into any desired intricate shape at lower cost. Although each of the pawls 131 has its circumferentially widened end facing radially outwardly, the stopper 130 and the pawls 131 become deformed radially inwardly during the insertion of the drain valve unit 100 into the drain valve hole 42. The drain valve unit 100 can be easily installed in the drain valve hole 42. The protrusion 120 makes point contact at its spherical end 123 with the bottom end face portion 53 of the filter element 52. This limits an axial rotation moment on the protrusion end 123 even when the protrusion 120 does not contact at the right angle with respect to the bottom end face portion 53 of the filter element 52, thereby decreasing a force exerted on the protrusion 120 in a direction other than the axial direction and reducing a load on the protrusion 120.

Furthermore, the valve retainer 110, the drain valve 140 and the spring 150 function as an opening/closing mechanism to allow or interrupt communication between the filter housing and the oil drain passage, as explained above, upon attachment and detachment of the cap 20 and the housing body 40. The oil overflow can be thus prevented assuredly at the time the filter apparatus 1 becomes disassembled for replacement of the filter 50.

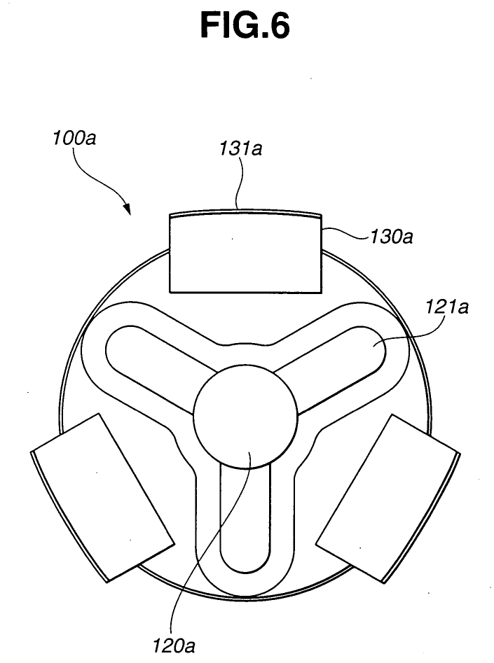

The second embodiment will be next described below with reference to FIG. 6. The second embodiment is structurally similar to the first embodiment, except for a drain valve unit 100a as shown in FIG. 6. The drain valve unit 100a has three stoppers 130a with respective pawls 141a and three protrusion ribs 121a alternating aligned around the protrusion 120. In order to prevent the pawls 131a from fitting into the communication hole 70 and thereby tilting the drain valve unit 100a, the circumferential width of each pawl 131a is herein made larger than the width of the communication hole 70.

It is noted that the number of the ribs 121 or 121a formed on the protrusion 120 is not particularly restricted in the first or second embodiment. It is however preferable to form three or more circumferentially evenly spaced ribs 121 or 121a in order to benefit from the reinforcement effects of the ribs 121 or 121a regardless of the circumferential orientation of the protrusion 120 and eliminate the need for the circumferential positioning between the stoppers 130 or 130a and the stopper retaining portion 43.

It is also noted that the number of the stoppers 130 or 130a arranged around the protrusion 120 is not particularly restricted in the first or second embodiment. However, it is preferable to provide four or more circumferentially evenly spaced stoppers 130 or 130a so that, even if one of the stoppers 130 or 130a fits in the communication hole 70, the drain valve unit 100 can be held in a vertical position with the other three or more stoppers 130 or 130a so as to prevent the protrusion 120 from becoming tilted. This also limits the axial rotation moment on the protrusion 120 and reduces the load on the protrusion 120.

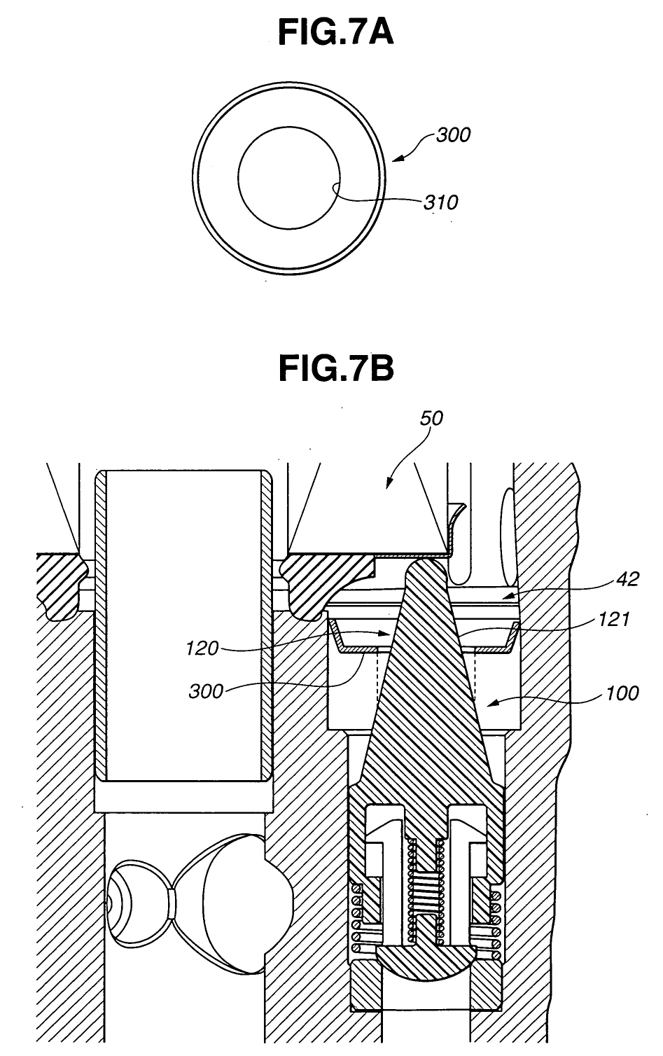

The third embodiment will be finally described below with reference to FIGS. 7A and 7B. The third embodiment is structurally similar to the first and second embodiments, except that the drain valve unit 100 (or 100a) has a different stopper (retaining) mechanism. More specifically, the stopper mechanism includes a crown-shaped retaining element 300 press fitted in the opening of the drain valve hole 42 in the third embodiment. The crown-shaped retaining element 300 is made of an elastic platy material and formed with a circular bottom opening 310 as shown in FIG. 7A. The valve protrusion 120 is movably passed through the opening 310 of the retaining element 300. When the filter 50 is placed in position, the protrusion ribs 121 are kept apart from the retaining element 30 such that the retaining element 30 does not interfere with the protrusion 120 as shown in FIG. 7B. The protrusion 120 is retained in the opening 310 of the retaining element 300 by engagement of the protrusion ribs 120 with the retaining element 300, thereby preventing the protrusion 120 from moving excessively upward at the time when the filter 50 becomes dismounted upon detachment of the cap 20 and the housing body 40 from each other. This makes it possible in the third embodiment to obtain the same effects as obtained in the first and second embodiments.

The entire contents of Japanese Patent Application No. 2004-118811 (filed on Apr. 14, 2004) are herein incorporated by reference.

Although the present invention has been described with reference to a specific embodiment of the invention, the invention is not limited to the above-described embodiment. Various modification and variation of the embodiment described above will occur to those skilled in the art in light of the above teaching. The scope of the invention is defined with reference to the following claims.

1. An oil filter apparatus, comprising:
a filter element;
a housing accommodating therein the filter element and having a housing body and a cap attached to the housing body;
an oil drain passage defined by the housing; and
a drain valve unit mounted to the oil drain passage, the drain valve unit comprising:
a protrusion arranged movably in an opening of the oil drain passage and having an end in contact with the filter element;
a biasing mechanism that biases the protrusion toward the filter element;
a plurality of stoppers formed around and being integral with the protrusion so as to prevent the protrusion from protruding excessively through the passage opening upon contact of the stoppers with a portion of the oil drain passage adjacent to the passage opening;
an opening/closing mechanism that opens and closes the oil drain passage in response to a movement of the protrusion; and
a rib formed integral with the protrusion so as to extend between the stoppers toward the protrusion end.

2. The oil filter apparatus of claim 1, wherein the stoppers have elastic pawls located outwardly of the protrusion so as to be deformed inwardly during insertion of the stoppers through the oil drain passage opening and be contactable with said passage portion after insertion of the stoppers through the oil drain passage opening.

3. The oil filter apparatus of claim 1, wherein the protrusion end makes point contact with the filter element.

4. The oil filter apparatus of claim 1, wherein three or more ribs are formed integrally with and circumferentially evenly spaced around the protrusion so as to extend toward the protrusion end.

5. The oil filter apparatus of claim 4, wherein the protrusion and the pawls are integrally formed of a synthetic resin.

6. The oil filter apparatus of claim 1, wherein four or more stoppers are formed integrally with and circumferentially evenly spaced around the protrusion.

7. The oil filter apparatus of claim 1,
the opening/closing mechanism comprising: a retainer arranged movably in the oil drain passage; a valve element mounted to the retainer; a valve seat formed in the oil drain passage in such a manner that the valve element is seated on and released from the valve seat; and a biasing element that biases the retainer away from the valve seat, and
the filter apparatus further comprising a structure that causes the retainer to move against a tension of the biasing element so as to seat the valve element on the valve seat and thereby interrupt communication between the housing and the oil drain passage in response to an input from the cap upon attachment of the cap to the housing body, and then, causes the retainer to move under the tension of the biasing member so as to release the valve element from the valve seat and thereby allow communication between the housing and the oil drain passage upon detachment of the cap from the housing body.

8. An oil filter apparatus, comprising:
a filter element;
a housing accommodating therein the filter element and having a housing body and a cap attached to the housing body, the housing body defining therein an oil drain passage;
a protrusion movably arranged in an opening of the oil drain passage and having a spherical end in contact with the filter element;
a biasing mechanism that biases the protrusion toward the filter element;
a stopper formed integrally with the protrusion so as to prevent the protrusion from protruding excessively through the passage opening upon contact of the stopper with a portion of the oil drain passage adjacent to the passage opening;
an opening/closing mechanism that opens and closes the oil drain passage in response to a movement of the protrusion; and
a triangular rib formed integrally with the protrusion so as to extend toward the protrusion end.

9. The oil filter apparatus of claim 8, wherein a plurality of triangular ribs are formed integrally with the protrusion.

10. The oil filter apparatus of claim 9, wherein four triangular ribs are formed integrally with the protrusion.

11. The oil filter apparatus of claim 9, wherein a plurality of stoppers are formed integrally with the protrusion in such a manner that each of the stoppers is located between any adjacent two of the ribs.

12. The oil filter apparatus of claim 8, wherein the opening/closing mechanism comprises a retainer that retains thereon the protrusion, the stopper and the rib, and the retainer, the protrusion, the stopper and the rib are integrally formed of a synthetic resin.

13. The oil filter apparatus of claim 12, wherein the retainer is arranged slidably in a retainer sliding portion of the oil drain passage, and the retainer sliding portion is of diameter to allow an axial sliding movement of the retainer but prevent a radial movement of the retainer.

14. The oil filter apparatus of claim 13, wherein a hole is formed in the retainer sliding portion for communication between the interiors of the housing and the oil drain passage.

15. The oil filter apparatus of claim 8, wherein the protrusion end makes contact with an end face portion of the filter element.

16. An oil filter apparatus, comprising:
a filter element;
a housing accommodating therein the filter element and having a housing body and a cap attached to the housing body, the housing body defining therein an oil drain passage;
a protrusion movably arranged in an opening of the oil drain passage and having an end in contact with the filter element;
a biasing mechanism that biases the protrusion toward the filter element;
an opening/closing mechanism that opens and closes the oil drain passage in response to a movement of the protrusion;
a rib formed integrally with the protrusion so as to extend toward the protrusion end; and
a retaining mechanism arranged adjacent to the oil drain passage opening, the retaining mechanism being released from the rib at the time of placing the filter element in position upon attachment of the cap to the housing body and then being engaged with the rib so as to prevent an axial movement of the protrusion at the time of dismounting the filter element upon detachment of the cap from the housing body.

17. The oil filter apparatus of claim 16, wherein the retaining mechanism comprises a crown-shaped element press fitted in the oil drain passage opening and having a circular opening in a bottom thereof.

18. The oil filter apparatus of claim 17, wherein the crown-shaped element has an elastic body.

19. The oil filter apparatus of claim 18, wherein the crown-shaped element is made of a platy material.

20. The oil filter apparatus of claim 16, wherein the rib is formed into a triangular shape so as to extend toward the protrusion end.
